(19) United States
(12) Patent Application Publication
(10) Pub. No.: US 2016/0090289 A1
(43) Pub. Date: Mar. 31, 2016

(54) Beverage Dispensing Box

(71) Applicant: David John Elger, Denver, CO (US)

(72) Inventor: David John Elger, Denver, CO (US)

(21) Appl. No.: 14/866,438

(22) Filed: Sep. 25, 2015

Related U.S. Application Data
(60) Provisional application No. 62/055,869, filed on Sep. 26, 2014.

(51) Int. Cl. B67D 3/00; B65D 77/06

(52) U.S. Cl. CPC B67D 3/0067; B65D 77/065

(57) ABSTRACT

A beverage dispensing box, which is configured to receive a quantity of spirits and to dispense a cocktail mixture, incorporates a front panel, a left panel, a rear panel, a right panel, a top flap assembly and a bottom flap assembly to delineate a storage volume. The storage volume houses a mixing bag. The mixing bag is selectively connected to the top flap assembly in order to receive a bottle of spirits. The contents of the bottle of spirits are drained into the mixing bag to be mixed with a cocktail mixture contained within the mixing bag in order to form a cocktail beverage. The cocktail mixture is proportioned ingredients to be a specific cocktail once a quantity of spirits are added. The mixing bag is able to be accessed through the front panel to dispense the cocktail beverage for a consumer.

The current application claims a priority to the U.S. Provisional Patent application Ser. No. 62/055,869 filed on Sep. 26, 2014.

### FIELD OF THE INVENTION

The present invention relates generally to a beverage dispensing container. More specifically, the present invention relates to a beverage dispensing container which an alcoholic beverage container is integrated to be mixed with the contents of the beverage dispensing container to dispense an alcoholic mixed drink.

### BACKGROUND OF THE INVENTION

Mixing alcoholic drinks is a common practice in order to remove the bitter taste from strong spirits Millions of mixed drinks and cocktails are created everyday throughout the world. Currently, people and bartenders utilize many different types of bottles and containers to mix such drinks. A majority of these cocktails require relative proportions of ingredients in order to be referred to as a specific cocktail mixture. Bartenders are typically trained to know these proportions and to be able to prepare cocktails quickly; however, amateurs may have difficulty with the proportions or may forget how to make certain cocktail mixtures.

It is therefore an object of the present invention to introduce an apparatus which is a beverage dispensing box that allows consumers to add liquor of their choice to a premade non-alcoholic cocktail mixture contained within the beverage dispensing box. The beverage dispensing box allows for a consistent cocktail mixture once the liquor of the consumer's choice is added.

### BRIEF DESCRIPTION OF THE DRAWINGS

FIG. 1 is a front perspective view of the present invention with the mixing bag removed.

FIG. 2 is a rear perspective view of the present invention with the mixing bag removed.

FIG. 3 is a front view of the present invention with the mixing bag removed.

FIG. 4 is a side cross-sectional view of the present invention with the mixing bag removed.

FIG. 5 is a side cross-sectional view of the present invention incorporating the mixing bag.

FIG. 6 is a schematic view of the front panel, the left panel, the right panel, the rear panel, the top flap assembly, and the bottom flap assembly in an unfolded configuration. The embodiment incorporating the perforated flap is also exemplified.

### DETAIL DESCRIPTIONS OF THE INVENTION

All illustrations of the drawings are for the purpose of describing selected versions of the present invention and are not intended to limit the scope of the present invention.

Traditionally, cocktail beverages are mixed with a certain proportion of other ingredients depending the cocktail the consumer desires. As mixed drinks are generally proportioned by the person making that specific drink, the amount of alcohol or the amount of other ingredients present varies between each drink. The present invention is a beverage dispensing box which allows the consistent mixing and dispensing of a cocktail beverage.

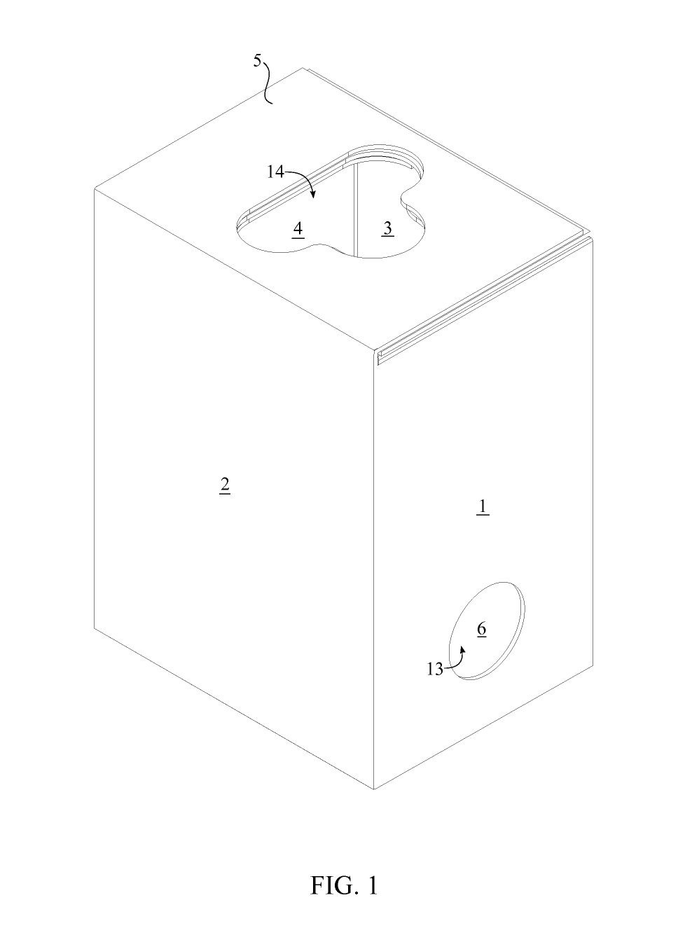

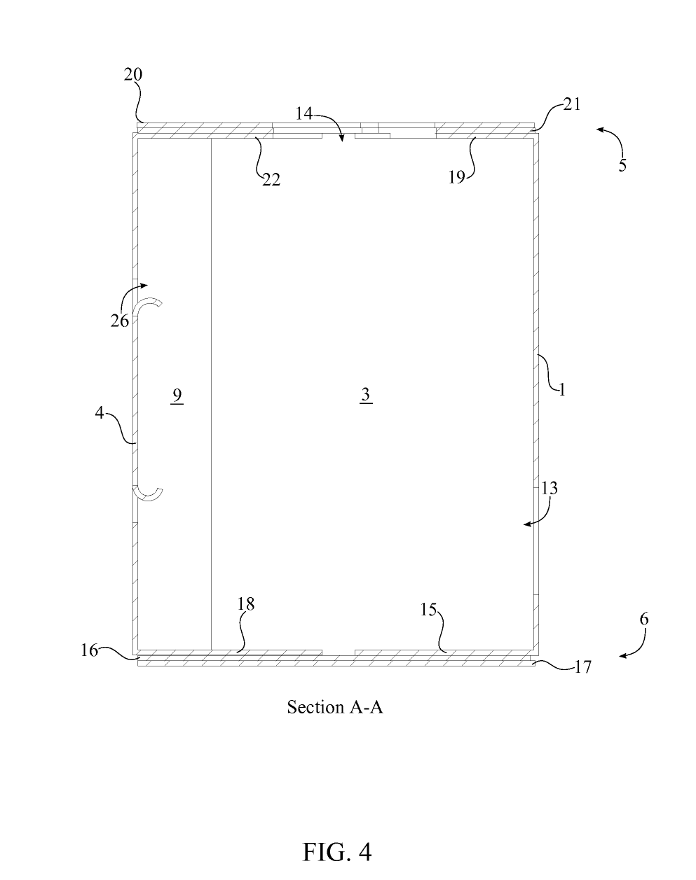

The present invention comprises a front panel 1, a left panel 2, a right panel 3, a rear panel 4, a top flap assembly 5, a bottom flap assembly 6, and a mixing bag 7. The right panel 3 is perpendicularly connected to the front panel 1. The left panel 2 is perpendicularly connected to the front panel 1, opposite to the right panel 3 across the front panel 1. The rear panel 4 is perpendicularly connected to the left panel 2 and the right panel 3, opposite to the front panel 1 and across both the left panel 2 and the right panel 3. The front panel 1, the left panel 2, the right panel 3, and the rear panel 4 each are perpendicularly connected to the top flap assembly 5, as shown in FIG. 1. The front panel 1, the left panel 2, the right panel 3, and the rear panel 4 each are perpendicularly connected to the bottom flap assembly 6, opposite to the top flap assembly 5, as detailed in FIG. 4. Thus, the front panel 1, the left panel 2, the right panel 3, the rear panel 4, the top flap assembly 5, and the bottom flap assembly 6 delineate a storage volume 8. This configuration allows for the present invention to be a rigid structure to contain the mixing bag 7, as the mixing bag 7 is internally positioned within the storage volume 8, as well as, allowing the present invention to be stackable and stored easily. In accordance to the preferred embodiment, the present invention comprises a securing flap 9. The securing flap 9 is foldably and adjacently connected to the rear panel 4, opposite to the left panel 2 across the rear panel 4. The securing flap 9 is adhered parallel to the right panel 3 such that the front panel 1, the left panel 2, the rear panel 4 and the right panel 3 securely form a rectangular prism.

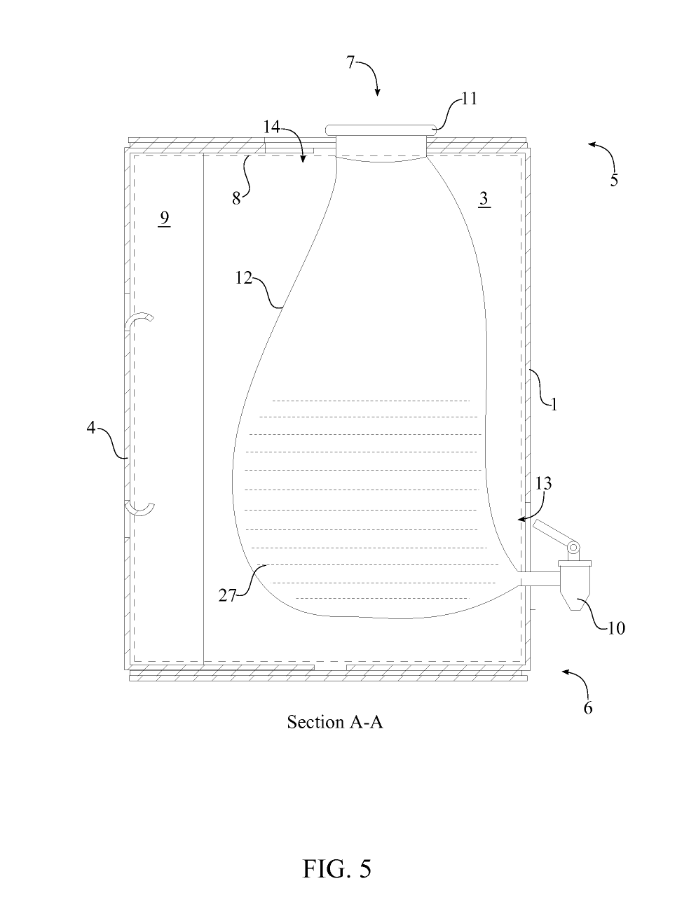

In accordance to FIG. 5, the mixing bag 7 comprises a pouring spout 10, a bottle receiving interface 11, and a flexible fluid storage container 12. The pouring spout 10 is a valve which the consumer operates in order to discharge a cocktail beverage. The bottle receiving interface 11 allows for the insertion for a mouth of a bottle of spirits while maintaining a seal which prevents the loss of contents within the flexible fluid storage container 12 through the bottle receiving interface 11. The pouring spout 10 traverses into the flexible fluid storage container 12. The bottle receiving interface 11 traverses into the flexible fluid storage container 12. The pouring spout 10 is in fluid communication with the bottle receiving interface 11 through the flexible fluid storage container 12, such that spirits can be introduced through the bottle receiving interface 11 and dispensed through the pouring spout 10.

In accordance to the preferred embodiment, a quantity of cocktail mixture 27 is contained within the flexible fluid storage container 12, as shown in FIG. 5. The quantity of cocktail mixture 27 is proportioned to provide sufficient quantities of ingredients for the desired cocktail. When a bottle of spirits is inserted into the bottle receiving interface 11, the contents of the bottle of spirits are drained into the flexible fluid storage container 12, such that the spirit is mixed with the quantity of cocktail mixture 27 to create a cocktail beverage. Since the quantity of spirits are available in standard volumes, the proportions of the quantity of cocktail mixture 27 is able to be made to accommodate these standard volumes of spirits in order to provide a consistent cocktail beverage.

As shown in FIG. 1 and FIG. 3 to FIG. 6, the present invention further comprises a spout orifice 13. The spout orifice 13 allows the pouring spout 10 to be positioned outside of the storage volume 8, such that the pouring spout 10 is readily accessible to consumers. The spout orifice 13 traverses through the front panel 1, adjacent to the bottom flap assembly 6. The pouring spout 10 is selectively engaged with the spout orifice 13, thus allowing the consumer is able to pull the pouring spout 10 from the storage volume 8 to be accessible and insert the pouring spout 10 into the storage volume 8 for storage.

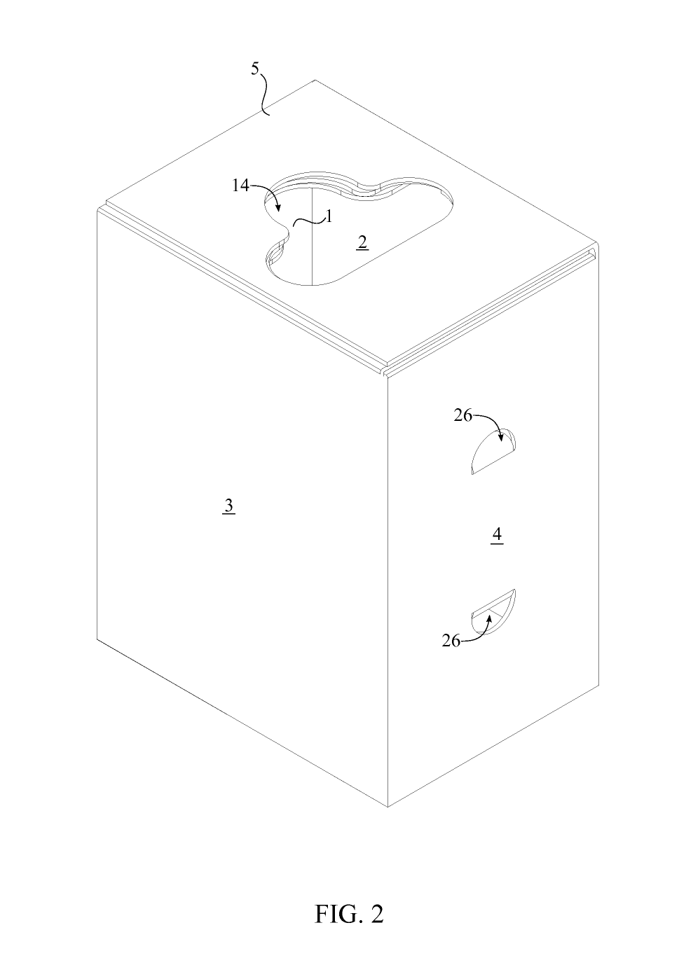

Similarly, the present invention comprises a bottle orifice 14, as exemplified in FIG. 1, FIG. 2, and FIG. 4 to FIG. 6. The bottle orifice 14 allows the bottle receiving interface 11 to be accessible externally to the storage volume 8. The bottle orifice 14 traverses through the top flap assembly 5. Thus, allowing for a bottle of spirits to be inserted into the bottle receiving interface 11 adjacent to the top flap assembly 5, such that the contents of the bottle of spirits are drained into the flexible fluid storage container 12. The bottle receiving interface 11 is selectively engaged with the bottle orifice 14, such that the consumer is able to pull the bottle receiving interface 11 from the storage volume 8 to be accessible and insert the bottle receiving interface 11 into the storage volume 8 when the present invention is not in use.

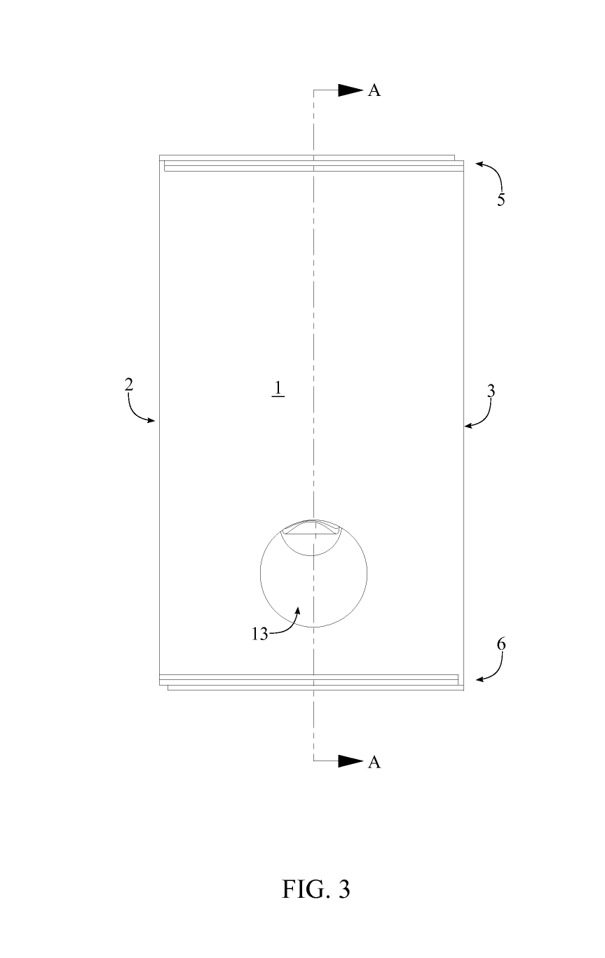

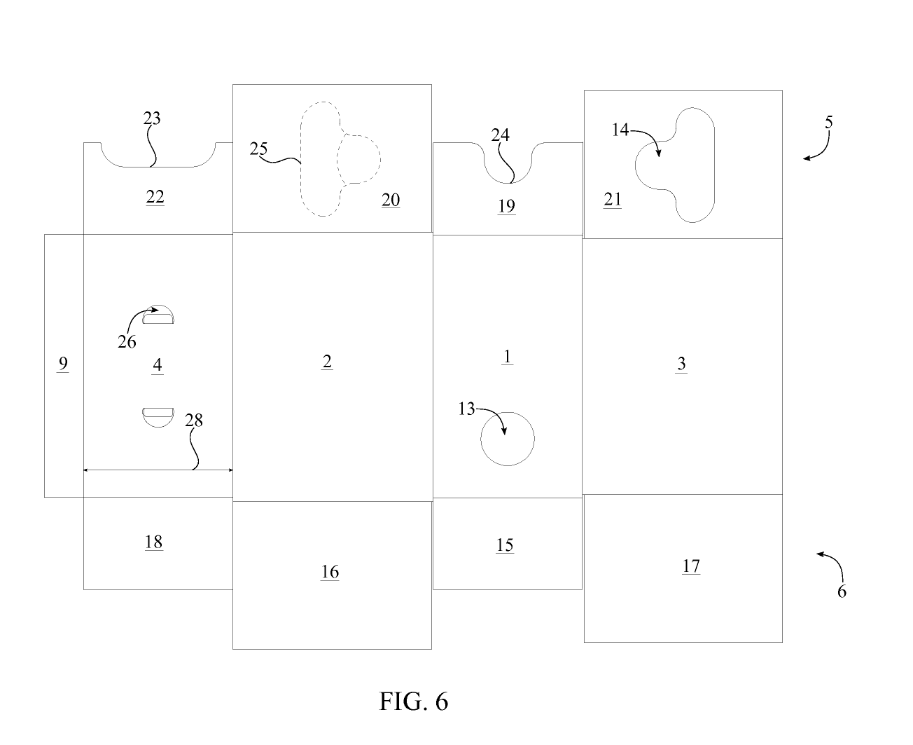

Further in accordance to the present embodiment and shown in FIG. 3 and FIG. 6, the bottom flap assembly 6 comprises a front bottom flap 15, a left bottom flap 16, a right bottom flap 17, and a rear bottom flap 18, in order to secure the contents within the storage volume 8. The front bottom flap 15, the left bottom flap 16, the right bottom flap 17, and the rear bottom flap 18 reinforce each other in order to strengthen the ability to retain the contents within the storage volume 8. The front bottom flap 15 is foldably and adjacently connected to the front panel 1, between the left panel 2 and the right panel 3. The left bottom flap 16 is foldably and adjacently connected to the left panel 2, between the rear panel 4 and the front panel 1. The right bottom flap 17 is foldably and adjacently connected to the right panel 3, adjacent to the front panel 1. The rear bottom flap 18 is foldably and adjacently connected to the rear panel 4, adjacent to the left panel 2. The front bottom flap 15 and the rear bottom flap 18 is adjacently positioned to each other. The front bottom flap 15, the left bottom flap 16, the right bottom flap 17, and the rear bottom flap 18 are adhered to each other in order to secure the top flap assembly 5 together. In some embodiments, the right bottom flap 17 is adjacently positioned to the front bottom flap 15 and the rear bottom flap 18, opposite to the top flap assembly 5. The left bottom flap 16 is adjacently positioned to the right bottom flap 17, opposite to the front bottom flap 15 and the rear bottom flap 18. In some other embodiments, the left bottom flap 16 is adjacently positioned to the front bottom flap 15 and the rear bottom flap 18, opposite to the top flap assembly 5. The right bottom flap 17 is adjacently positioned to the left bottom flap 16, opposite to the front bottom flap 15 and the rear bottom flap 18.

Similarly, the top flap assembly 5 comprises a front top flap 19, a left top flap 20, a right top flap 21, and a rear top flap 22 which reinforce each other to strengthen the top flap assembly 5 in order to support the weight for a bottle of spirits, as depicted in FIG. 3 and FIG. 6. The front top flap 19 is foldably and adjacently connected to the front panel 1, between the left panel 2 and the right panel 3. The left top flap 20 is foldably and adjacently connected to the left panel 2, between the rear panel 4 and the front panel 1. The right top flap 21 is foldably and adjacently connected to the right panel 3, adjacent to the front panel 1. The rear top flap 22 is foldably and adjacently connected to the rear panel 4, adjacent to the left panel 2. The front top flap 19 and the rear top flap 22 are positioned adjacent to each other. The bottle orifice 14 traverses through the front top flap 19, the left top flap 20, the right top flap 21, and the rear top flap 22, such that the storage volume 8 is accessible through the bottle orifice 14.

In accordance to the preferred embodiment, the present invention comprises a perforated flap 25, as shown in FIG. 6. The perforated flap 25 is selectively positioned by the consumer to access to the storage volume 8 through the bottle orifice 14 and is able to be positioned to secure the bottle receiving interface 11 to the top flap assembly 5. The perforated flap 25 is integrated within the bottle orifice 14 of the left top flap 20, as the left top flap 20 is preferred to be the outermost flap of the top flap assembly 5. The right top flap 21 is adjacently positioned to the front top flap 19 and the rear top flap 22, opposite to the bottom flap assembly 6. The left top flap 20 is adjacently positioned onto the right top flap 21, opposite to the front top flap 19 and the rear top flap 22.

As shown in FIG. 6, the bottle orifice 14 comprises a semi-elliptical portion 23 and a semi-circular portion 24. The semi-elliptical portion 23 being adjacent to the semi-circular portion 24. The semi-elliptical portion 23 traverses through the rear top flap 22, opposite to the rear panel 4, while the semi-circular portion 24 traverses through the front top flap 19, opposite to the front panel 1. As the bottle receiving interface 11 is positioned to engage the bottle orifice 14, the bottle receiving interface 11 is positioned through the semi-circular portion 24. The perforated flap 25 is then able to be positioned adjacent to both the semi-elliptical portion 23 and the bottle receiving interface 11 in order to secure the bottle receiving interface 11 through the bottle orifice 14.

Further in accordance to the preferred embodiment, the present invention comprises at least one finger hold 26, as shown in FIG. 2 and FIG. 4 to FIG. 6. The at least one finger hold 26 allows for ease of manipulation and transport of the present invention. The at least one finger hold 26 is integrated into the rear panel 4 and is centrally positioned along a width 28 of the rear panel 4 such that the present invention is able to be easily pushed, pulled or lifted. Similar to the perforated flap 25, in some embodiments of the present invention, the present invention comprises at least one perforated finger hold flap. A finger hold flap of the at least one perforated finger hold flap is hingedly integrated into a finger hold of the at least one finger hold 26. The at least one perforated finger hold flap covers the at least one finger hold 26 in order to prevent piercing or abrasive damage to the contents within the storage volume 8.

Although the invention has been explained in relation to its preferred embodiment, it is to be understood that many other possible modifications and variations can be made without departing from the spirit and scope of the invention as hereinafter claimed.

What is claimed is:

1. A beverage dispensing box comprises:
a front panel;
a left panel;
a right panel;
a rear panel;
a top flap assembly;
a bottom flap assembly;
a mixing bag;
the right panel being perpendicularly connected to the front panel;
the left panel being perpendicularly connected to the front panel, opposite to the right panel across the front panel;
the rear panel being perpendicularly connected to the left panel and the right panel, opposite to the front panel across both the left panel and the right panel;
the front panel, the left panel, the right panel, and the rear panel each being perpendicularly connected to the top flap assembly;
the front panel, the left panel, the right panel, and the rear panel each being perpendicularly connected to the bottom flap assembly, opposite to the top assembly;
the front panel, the left panel, the right panel, the rear panel, the top flap assembly, and the bottom flap assembly delineating a storage volume; and
the mixing bag being internally positioned within the storage volume.

2. The beverage dispensing box, as claimed in claim 1, comprises:
a securing flap;
the securing flap being foldably and adjacently connected to the rear panel, opposite to the left panel across the rear panel; and
the securing flap being adhered parallel to the right panel.

3. The beverage dispensing box, as claimed in claim 1, comprises:
the mixing bag comprises a pouring spout, a bottle receiving interface, and a flexible fluid storage container;
the pouring spout traversing into the flexible fluid storage container;
the bottle receiving interface traversing into the flexible fluid storage container; and
the pouring spout being in fluid communication with the bottle receiving interface through the flexible fluid storage container.

4. The beverage dispensing box, as claimed in claim 3, wherein a quantity cocktail mixture is contained within the flexible fluid storage container.

5. The beverage dispensing box, as claimed in claim 3, comprises:
a spout orifice;
a pouring spout;
the spout orifice traversing through the front panel, adjacent to the bottom flap assembly; and
the pouring spout being selectively engaged with the spout orifice.

6. The beverage dispensing box, as claimed in claim 3, comprises:
a bottle orifice;
a bottle receiving interface;
the bottle orifice traversing through the top flap assembly; and
the bottle receiving interface being selectively engaged with the bottle orifice.

7. The beverage dispensing box, as claimed in claim 1, comprises:
the bottom flap assembly comprises a front bottom flap, a left bottom flap, a right bottom flap, and a rear bottom flap;
the front bottom flap being foldably and adjacently connected to the front panel, between the left panel and the right panel;
the left bottom flap being foldably and adjacently connected to the left panel, between the rear panel and the front panel;
the right bottom flap being foldably and adjacently connected to the right panel, adjacent to the front panel;
the rear bottom flap being foldably and adjacently connected to the rear panel, adjacent to the left panel; and
the front bottom flap and the rear bottom flap being adjacently positioned to each other.

8. The beverage dispensing box, as claimed in claim 7, comprises:
the right bottom flap being adjacently positioned to the front bottom flap and the rear bottom flap, opposite to the top flap assembly; and
the left bottom flap being adjacently positioned to the right bottom flap, opposite to the front bottom flap and the rear bottom flap.

9. The beverage dispensing box, as claimed in claim 7, comprises:
the left bottom flap being adjacently positioned to the front bottom flap and the rear bottom flap, opposite to the top flap assembly; and
the right bottom flap being adjacently positioned to the left bottom flap, opposite to the front bottom flap and the rear bottom flap.

10. The beverage dispensing box, as claimed in claim 1, comprises:
a bottle orifice;
the top flap assembly comprises a front top flap, a left top flap, a right top flap, and a rear top flap;
the front top flap being foldably and adjacently connected to the front panel, between the left panel and the right panel;
the left top flap being foldably and adjacently connected to the left panel, between the rear panel and the front panel;
the right top flap being foldably and adjacently connected to the right panel, adjacent to the front panel;
the rear top flap being foldably and adjacently connected to the rear panel, adjacent to the left panel;
the front top flap and the rear top flap being positioned adjacent to each other; and
the bottle orifice traversing through the front top flap, the left top flap, the right top flap, and the rear top flap.

11. The beverage dispensing box, as claimed in claim 10, comprises:
the right top flap being adjacently positioned adjacent to the front top flap and the rear top flap, opposite to the bottom flap assembly; and
the left top flap being adjacently positioned onto the right top flap, opposite to the front top flap and the rear top flap.

12. The beverage dispensing box, as claimed in claim 10, comprises:
the bottle orifice comprises a semi-elliptical portion;
the semi-elliptical portion traversing through the rear top flap, opposite to the rear panel;

[symbol]

13. The beverage dispensing box, as claimed in claim 10, comprises:
the bottle orifice comprises a semi-circular portion; and
the semi-circular portion traversing through the front top flap, opposite to the front panel.

14. The beverage dispensing box, as claimed in claim 10, comprises:
a perforated flap; and
the perforated flap being integrated within the bottle orifice of the left top flap.

15. The beverage dispensing box, as claimed in claim 1, comprises:
at least one finger hold;
the at least one finger hold being integrated into the rear panel; and
the at least one finger hold being centrally positioned along a width of the rear panel.
